(19) United States
(12) Patent Application Publication
(10) Pub. No.: US 2013/0278699 A1
(43) Pub. Date: Oct. 24, 2013

(54) PRINTER AND PRINT METHOD

(71) Applicant: Kazuyuki Yoshikoshi, Shizuoka (JP)

(72) Inventor: Kazuyuki Yoshikoshi, Shizuoka (JP)

(73) Assignee: TOSHIBA TEC KABUSHIKI KAISHA, Tokyo (JP)

(21) Appl. No.: 13/450,592

(22) Filed: Apr. 19, 2012

(51) Int. Cl. B41J 2/01

(52) U.S. Cl. 347/107

(57) ABSTRACT

A printer includes a determining unit configured to determine whether a two-dimensional code complies with a readout condition of a printed matter when inserting an insert image into the two-dimensional-code image supplied from outside, and printing the two-dimensional-code image inserted with the insert image. The printer further includes a print unit configured to print, on a recording medium, the two-dimensional-code image inserted with the insert image if the determining unit determines that the two-dimensional code complies with the readout condition within a predetermined range.

### FIELD

Embodiments described herein relate generally to a printer and print method for printing a barcode or a two-dimensional code (QR code) on a recording medium using an ink ribbon or the like.

### BACKGROUND

In recent years, the manner of using printers becomes increasingly complicated and diversified. There is available a printer for printing a barcode or a two-dimensional code (QR code) on a recording medium using an ink ribbon or the like. In this type of printer, printing functions may be performed by inserting an insert image into a two-dimensional code (QR code).

### BRIEF DESCRIPTION OF THE DRAWINGS

FIG. 1 is a perspective view showing one example of an exterior appearance of a printer.

FIG. 2 is an explanatory view showing one example of a mechanical configuration of the printer of FIG. 1.

FIG. 3 is a block diagram illustrating one example of an electrical configuration of the printer of FIG. 1.

FIGS. 4A through 4D are explanatory views illustrating different examples of a QR image having an insert image inserted therein, which are printed by the printer of FIG. 1.

FIG. 5 is a flowchart for illustrating a printing process of a two-dimensional code performed by the printer of FIG. 1.

FIG. 6 is a flowchart for illustrating a printing process of a two-dimensional code performed by the printer of FIG. 1 in response to receiving instructions from an external personal computer.

### DETAILED DESCRIPTION

According to some embodiments, a printer includes a determining unit configured to determine whether a two-dimensional code complies with a readout condition of a printed matter when inserting an insert image into a two-dimensional-code image. The printer further includes a print unit configured to print, on a recording medium, the two-dimensional-code image inserted with the insert image if the determining unit determines that the two-dimensional code complies with the readout condition within a predetermined range.

Reference will now be made in detail to various embodiments of the subject matter, examples of which are illustrated in the accompanying drawings. In the following detailed description, numerous specific details are set forth in order to provide a thorough understanding of the present subject matter. However, it will be apparent to one of ordinary skill in the art that the present subject matter may be practiced without these specific details. In other instances, well-known methods, procedures, systems, and components have not been described in detail so as not to unnecessarily obscure aspects of the described subject matter.

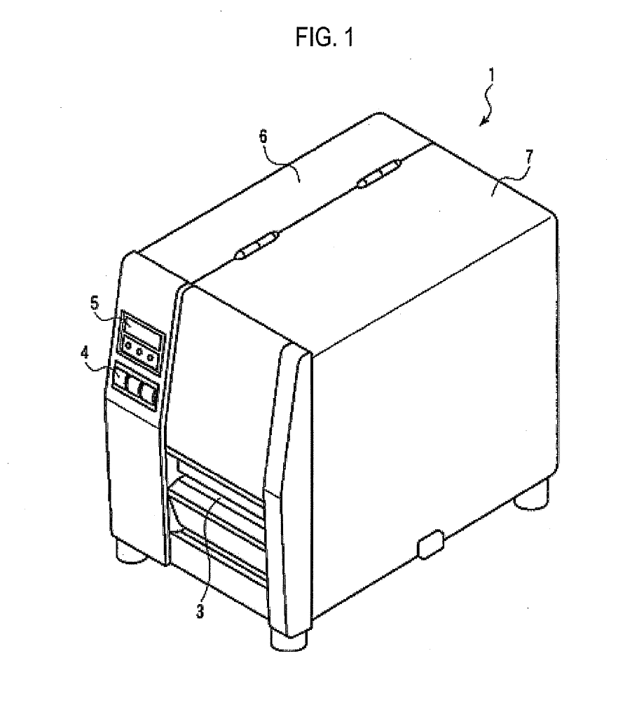

A printer 1 according some embodiments is described in detail with reference to FIGS. 1 through 3. Referring to FIG. 1, the printer 1 includes a control box 6 for housing a printer engine (not shown), an operation unit 4 provided on the front surface of the control box 6, and a display unit 5 formed of a liquid crystal screen and configured to display operation information or operation menus. Adjacent to the control box 6 is a cover 7 rotatably connected to the control box 6 by a hinge. The cover 7 includes a discharge port 3 provided on the front surface of the cover 7 to discharge a printed recording medium through the port 3.

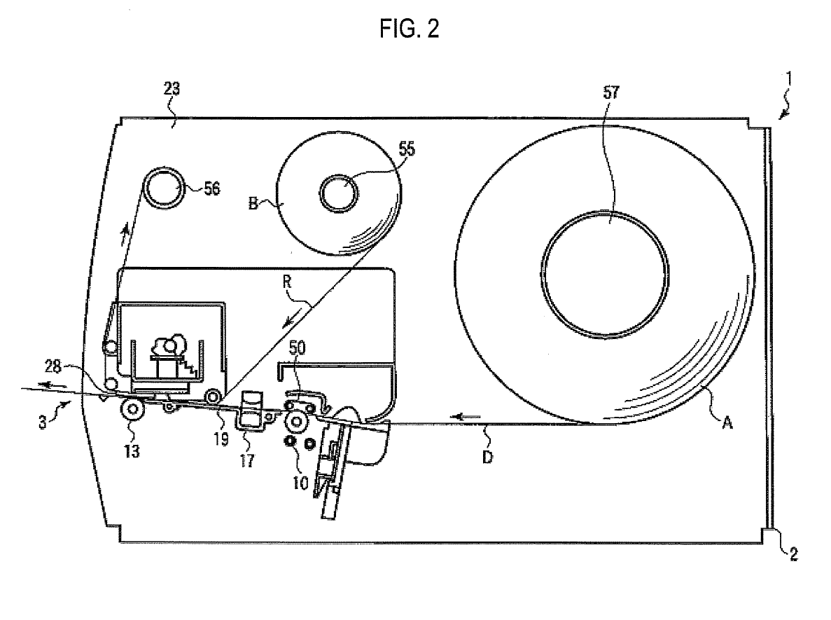

Referring now to FIG. 2, the printer 1 further includes a paper holding unit 57 configured to rotatably hold a paper roll A, a ribbon supply shaft 55 configured to hold an ink ribbon roll B to supply an ink ribbon R, and a ribbon take-up shaft 56 configured to wind and hold the ink ribbon R supplied from the ribbon supply shaft 55, all of which are seen in the interior 23 of the printer 1 when the cover 7 is opened. The printer 1 further includes a conveying roller 10 configured to convey a paper D supplied from the paper roll A held in the paper holding unit 57, a pinch roller 50 configured to pinch the paper D, a paper detecting sensor 17 configured to detect the paper D, a conveying path 19 upon which the ink ribbon roll B is supplied from the ribbon supply shaft 55, a platen roller 13 configured to convey the ink ribbon roll B and the paper D, and a thermal head 28 configured to perform printing on the paper D. The paper D thus printed is discharged from the discharge port 3.

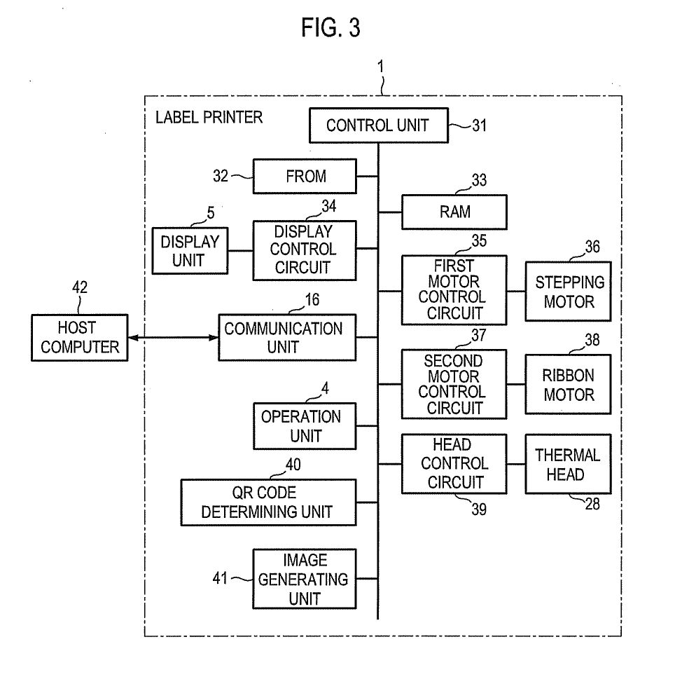

Referring to FIG. 3, which is a block diagram illustrating one example of the electrical configuration of the printer 1 capable of printing a two-dimensional code image, the printer 1 includes a control unit 31 to control the operations of all the parts or units, a FROM (Floating Read Only Memory) 32 and a RAM (Random Access Memory) 33 to store operation information, setting information and operation programs. The printer 1 further includes a display control circuit 34 to control the operation of the display unit 5, which is formed of liquid crystal display and connected to the display control circuit 34. The printer 1 further includes a communication unit 16 configured to, in concert with the operation unit 4, perform communication with a host computer 42 provided outside the printer 1 and operated by a user. Further, the printer 1 includes a stepping motor 36 configured to drive various components of the printer 1, (e.g., the conveying roller 10, the platen roller 13 and the pinch roller 50), a first motor control circuit 35 configured to control the stepping motor 36, a ribbon motor 38 configured to drive the ribbon take-up shaft 56, a second motor control circuit 37 configured to control the ribbon motor 38 and a head control circuit 39 configured to control the thermal head 28. The printer 1 further includes a QR code determining unit 40 configured to determine whether a two-dimensional code meets a readout condition and an image generating unit 41 configured to generate the two-dimensional code image. The readout condition (which will be described later) may be provided from the host computer 42 through communication unit 16 and may be stored in the RAM 33. The FROM 32, the RAM 33, the display control circuit 34, the communication unit 16, the first motor control circuit 35, the motor control circuit 37, the operation unit 4, the head control circuit 39, the QR code determining unit 40 and the image generating unit 41 are connected to the control unit 31.

In the printer 1 configured as above, in response to the operations of the operation unit 4 or instructions from the host computer 42, the thermal head 28 performs printing operations on the paper D (as the recording medium) under the control of the control unit 31. The paper D is conveyed by the conveying roller 10, the platen roller 13 and the pinch roller 50 and is discharged to the discharge port 3.

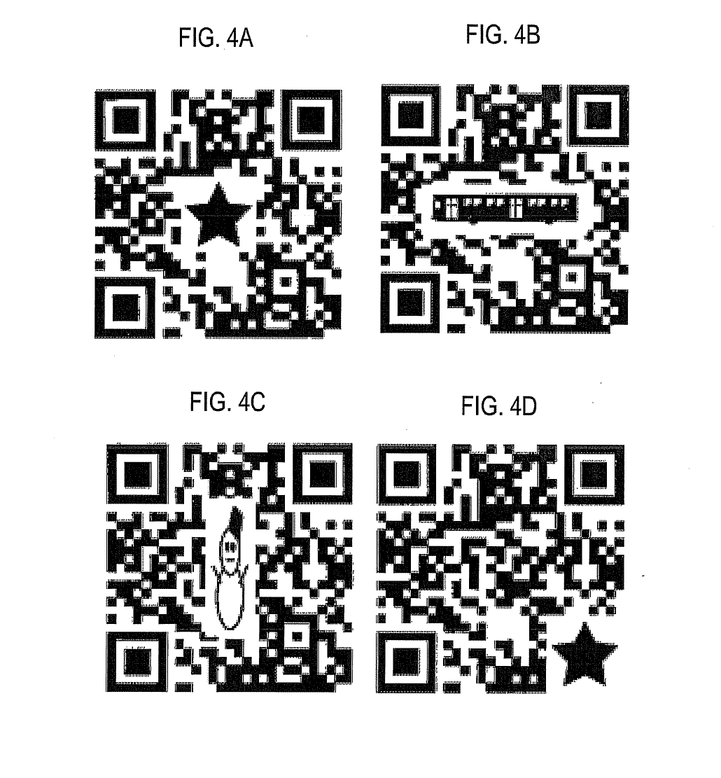

Next, the generation of a two-dimensional code (QR code) in the printer 1 configured as above will be described in detail with reference to FIGS. 4 through 6.

Examples of two-dimensional codes (QR codes) having an insert image inserted therein are described with reference to FIGS. 4A through 4D. FIG. 4A shows one example of an image in which the insert image is a star-shaped mark, and is inserted into an area at a central position of the two-dimensional code (QR code). FIG. 4B shows another example of an insert image as a train-shaped mark inserted into a horizontally-extending area at the central position of the two-dimensional code (QR code). FIG. 4C shows another example of an image in which the insert image is a snowman-shaped mark inserted into a vertically-extending area at the central position of the two-dimensional code (QR code). FIG. 4D shows yet another example of an insert image in the shape of a star-shaped mark inserted into an area at the right lower position of the two-dimensional code (QR code). Thus, a printing readout condition can depend on any insertion position, size and shape of the insert image, such as the examples shown in FIGS. 4A through 4D.

Printer 1 may for example be a label printer, and may include an image buffer (not shown) with a storage capability corresponding to a specified paper size provided by the image generating unit 41 of FIG. 3. An image of a two-dimensional code, which may contain some text information, may be rendered in the image buffer. The data of the image rendered in the image buffer may be transmitted to the thermal head 28 on a line-by-line basis and printed on a recording medium, such as on paper D.

The image generating unit 41 may be configured to include a function of erasing a designated portion (“superimposed area”) of the two-dimensional code image for superimposing an insert image over the designated portion. Such a superimposed area may be designated when rendering a two-dimensional-code image in the image buffer of the image generating unit 41. Further, the image generating unit 41 may include a function for rendering a two-dimensional-code image in which an insert image can be inserted into the two-dimensional code image. The QR code determining unit 40 may determine whether the partially erased two-dimensional code image is normally read out within a tolerable error correction rate or normal readout rate (e.g., 30%), using a two-dimensional-code error correction function of a two-dimensional-code reader engine.

In some embodiments, by forming an erased portion in the two-dimensional code, as described above, it can be determined in advance whether the two-dimensional code meets a readout condition of a printed matter, by executing a two-dimensional-code error correction function to make error computations. It is also possible to recognize in advance any constraints on the error correction level and the insertion position of the insert image. In other words, it is possible to determine whether the error correction can be normally performed depending on the insertion position and size of the insert image. This makes it possible to prevent the insert image from being erroneously inserted into an area in the two-dimensional code image that should not be erased to conform to the two-dimensional-code readout function. Accordingly, a proper image insertion area can be specified while complying with the requirements of the two-dimensional code.

The image insertion area may be displayed beforehand on, e.g., a display screen of the host computer 42 (e.g., a personal computer as an external device) or the display unit 5 of the printer 1 (e.g., as a label printer). This makes it possible to easily notify a user of the image insertion area before the printout is executed.

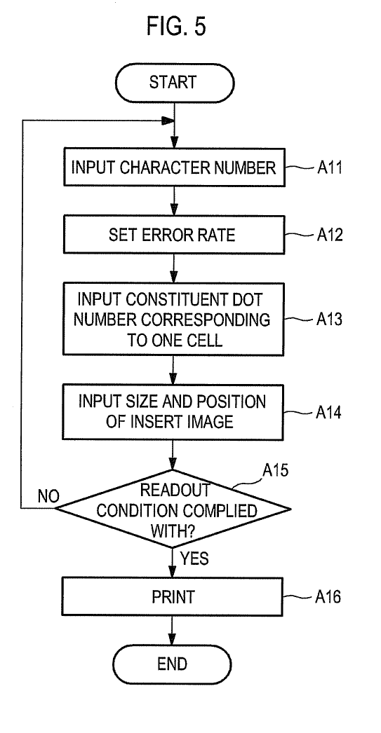

Next, specific operations of inserting an insert image into a two-dimensional code using the printer 1 as a label printer is described in detail with reference to the flowchart shown in FIG. 5. The number of characters used in forming an image of a two-dimensional code (QR code), is inputted from the operation unit 4 or the communication unit 16 to the control unit 31 of the printer 1 (Act A11). Then, an error rate allowed in reading out the two-dimensional code (QR code) is set (Act A12) and the number of constituent dots per cell in the two-dimensional code is inputted (Act A13). While these values (the number of characters, the error rate and the number of constituent dots) are inputted by the operation unit 4 or the communication unit 16, which functions as an input unit, and prestored in the RAM 33, these values may be automatically set to predetermined default values. Moreover, the size and insertion position of an insert image is specified by the operation unit 4 or the communication unit 16 (Act A14). When the input of such information is completed, the control unit 31 and the image generating unit 41 erase a specified portion of the two-dimensional-code (QR-code) image corresponding to the insertion position and size of the insert image, based on the inputted information. The control unit 31 and the QR code determining unit 40, utilizing a two-dimensional-code error correction function (Act A15), determine whether the two-dimensional code (QR code) image with the erased portion is readable within the error rate after insertion of the insert image.

If the two-dimensional code (QR code) is determined to be readable by the control unit 31 and the QR code determining unit 40, the image generating unit 41 generates a two-dimensional-code (QR-code) image based on the provided characters, or the like, and inserts the provided insert image into the two-dimensional-code (QR-code) image under the above-described insertion condition (e.g., based on the insertion position and size of the insert image), thereby generating a composite image. Based on the composite image supplied from the image generating unit 41, the thermal head 28 may print, on a recording medium such as a label, various types of two-dimensional codes (QR codes) as illustrated in FIGS. 4A through 4B, each of which has an insert image inserted therein (Act A16). The image generating unit 41 may insert the insert image onto the two-dimensional code (QR code) after enlarging and extending in a certain direction, according to required conditions. For example, the insert image may be in conformity with the insertion condition such as the insertion position, size and shape of the insert image, and so on.

Since the insert image inserting process and the determining process as described above may affect the printing throughput, the control unit 31 may switch on and off the insert image inserting process and the determining process. For example, if the printing needs to be performed in an expedited manner, the insert image inserting process and the determining process may be turned off.

Also, according some embodiments, a two-dimensional code generating process, including the insert image inserting process and the determining process, may be performed internally in a printer. Thus, the two-dimensional code can be generated in such a manner that the generated code is optimally customized according to the throughput of the printer. Also, this makes it possible for the printer to operate in its optimal performance condition irrespective of the other conditions related to an external device such as a host computer.

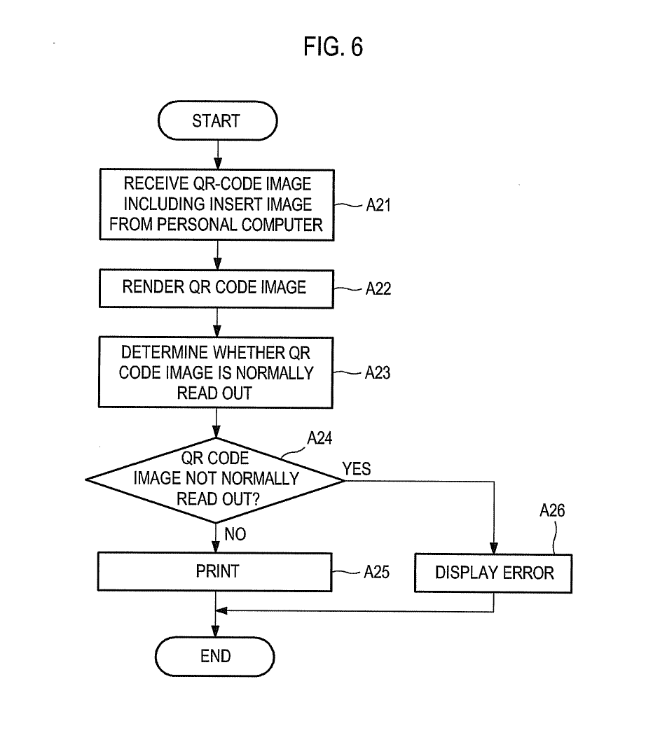

In alternate embodiments, the insert image inserting process and the determining process may be positively performed using the host computer 42, which functions as an input unit or the personal computer as an external device, as described with reference to the flowchart shown in FIG. 6.

More specifically, the control unit 31 of the printer 1 as a label printer receives a two-dimensional code (QR code) inserted with an insert image in advance from the host computer 42 or the personal computer through the communication unit 16 (Act A21). The control unit 31 and the image generating unit 41 renders an image on a buffer based on the given QR code image (Act A22). Then, the control unit 31 and the QR code determining unit 40 determine whether the rendered QR code image is normally read out within a range of a normal readout rate (e.g., 30%), using a two-dimensional-code error correction function of a two-dimensional-code reader engine (Act A23).

If it is determined that the rendered QR code image is not normally read out within a range of normal readout rate (e.g., 30%) (Act A24), the control unit 31 and the QR code determining unit 40 display an occurrence of an error on the display unit 5 of the printer 1, the display screen of the host computer 42 or the display screen of the personal computer, and also display information on how to change the insertion options (such as the size, shape and position of the insert image) to enable normal printing (Act A26). If it is determined that the rendered QR code image is normally read out within a range of normal readout rate (e.g., 30%) (Act A24), the control unit 31 and the QR code determining unit 40 controls the thermal head 28 to print a QR code image inserted with the insert image (see, e.g., FIG. 4A through 4D) on a recording medium such as a label (Act A25).

As described above, the printer 1 can determine in advance whether the two-dimensional code (QR code) inserted with the insert image in accordance with a predetermined insert image insertion condition complies with the readout condition. This eliminates the waste of time and resources due to erroneous printing of an unreadable QR code image.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, or can be installed in the apparatus from a computer readable storage medium storing the program therein. A form of the computer readable storage medium can be any form as long as the computer readable storage medium can store programs and is readable from an apparatus such as a disk type ROM and a solid-state computer storage media. The functions, obtained by installation or download in advance, in this way can be realized in cooperation with an OS (Operating System) in the apparatus.

While certain embodiments have been described, these embodiments have been presented by way of example only, and are not intended to limit the scope of the inventions. Indeed, the novel printer and print method described herein may be embodied in a variety of other forms or in combination any part(s) of the various embodiments described. Furthermore, various omissions, substitutions and changes in the form of the embodiments described herein may be made without departing from the spirit or scope of the inventions. The accompanying claims and their equivalents are intended to cover such forms or modifications as would fall within the scope and spirit of the inventions.

What is claimed is:

1. A printer, comprising:
a determining unit configured to determine whether a two-dimensional code image complies with a readout condition for a printed matter having an insert image configurable to insert into the two-dimensional-code image; and
a print unit configured to print, on a recording medium, the two-dimensional-code image inserted with the insert image if the determining unit determines that the two-dimensional code image complies with the readout condition within a predetermined range.

2. The printer of claim 1, further comprising:
an input unit configured to input to the determining unit the two-dimensional-code image, the insert image and an insertion condition under which the insert image is inserted into the two-dimensional-code image,
wherein the determining unit is configured to determine, based on the insertion condition, whether the two-dimensional code image complies with the readout condition when inserting the insert image into the two-dimensional-code image.

3. The printer of claim 2, wherein the insertion condition includes at least one from a group consisting of a size and position of the insert image, the number of characters in the two dimensional code image, an error rate and the number of constituent dots per cell in the two dimensional code image.

4. The printer of claim 1, further comprising:
an input unit configured to input the two-dimensional-code image and the insert image; and
an image generating unit configured to generate the two-dimensional-code image inserted with the insert image, based on the two-dimensional-code image and the insert image inputted by the input unit, and to supply the two-dimensional-code image inserted with the insert image to the print unit.

5. The printer of claim 4, wherein the input unit is configured to receive the two-dimensional-code image inserted with the insert image in advance from an external device, and
wherein the determining unit is configured to determine, based on the two-dimensional-code image inserted with the insert image in advance from the external device, whether the two-dimensional code complies with the readout condition.

6. A print method, comprising:
receiving a two-dimensional code image and a readout condition of a printed matter for inserting an insert image into the two-dimensional code image;
determining whether the two-dimensional code image complies with the received readout condition of the printed matter when inserting an insert image into the two-dimensional-code image; and
printing, by a printing unit, on a recording medium, the two-dimensional-code image inserted with the insert image if it is determined that the two-dimensional code image complies with the readout condition within a predetermined range.

7. The method of claim 6, further comprising:
inputting, by an input unit, the two-dimensional-code image, the insert image and an insertion condition under which the insert image is inserted into the two-dimensional-code image,
wherein determining includes determining, based on the insertion condition, whether the two-dimensional code image complies with the readout condition when inserting the insert image into the two-dimensional-code image.

8. The method of claim 7, wherein the insertion condition includes at least one from a group consisting of a size and position of the insert image, the number of characters in the two dimensional code image, an error rate and the number of constituent dots per cell in the two dimensional code image.

9. The method of claim 6, further comprising:
inputting, by an input unit, the two-dimensional-code image and the insert image; and
generating, by an image generating unit, the two-dimensional-code image inserted with the insert image, based on the two-dimensional-code image and the insert image inputted by the input unit, and to supply the two-dimensional-code image inserted with the insert image to the print unit.

10. The method of claim 9, wherein inputting includes receiving, by the input unit, the two-dimensional-code image inserted with the insert image in advance from an external device, and
wherein determining includes determining, based on the two-dimensional-code image inserted with the insert image in advance from the external device, whether the two-dimensional code complies with the readout condition when printing the two-dimensional-code image inserted with the insert image in advance.
